(19) United States
(12) Patent Application Publication
(10) Pub. No.: US 2015/0122112 A1
(43) Pub. Date: May 7, 2015

(54) SENSING KEY PRESS ACTIVATION

(71) Applicants: Michael Prichard, Carlisle, MA (US); Tymm Twillman, San Francisco, CA (US)

(72) Inventors: Michael Prichard, Carlisle, MA (US); Tymm Twillman, San Francisco, CA (US)

(73) Assignee: MISELU INC., San Francisco, CA (US)

(21) Appl. No.: 14/070,557

(22) Filed: Nov. 3, 2013

(51) Int. Cl. G10H 1/00; G10G 3/04

(52) U.S. Cl. CPC G10H 1/0016; G10G 3/04
USPC 84/724

(57) ABSTRACT

Embodiments generally relate to sensing key press activation. In one embodiment, a method includes providing a signal in an electronic device. The method further includes causing the signal to reflect off of a key of the electronic device. The method further includes determining a movement of the key based on a reflection of the signal.

### BACKGROUND

The creation of music is a popular activity enjoyed by many people. Various musical instrument devices and music applications enable a user to create music. Such devices and applications provide sounds that emulate the sounds of musical instruments. For example, a keyboard with piano keys when pressed may make piano sounds.

### SUMMARY

Embodiments generally relate to sensing key press activation. In one embodiment, a method includes providing a signal in an electronic device. The method further includes causing the signal to reflect off of a key of the electronic device. The method further includes determining a movement of the key based on a reflection of the signal.

In another embodiment, a system includes one or more processors, and logic encoded in one or more tangible media for execution by the one or more processors, and when executed operable to perform operations including providing a signal in an electronic device. The logic when executed is further operable to perform operations including causing the signal to reflect off of a key of the electronic device. The logic when executed is further operable to perform operations including determining a movement of the key based on a reflection of the signal.

In another embodiment, an electronic device includes an emitter that provides a signal in the electronic device, where the signal reflects off of a key of the electronic device. The electronic device further includes a processor that determines a movement of the key based on a reflection of the signal.

### BRIEF DESCRIPTION OF THE DRAWINGS

FIG. 1 is a block diagram of an example system, which may be used to implement the embodiments described herein.

FIG. 2 is a perspective-view diagram showing an example music device, according to some embodiments.

FIG. 3 is a side-view diagram showing an example sensing mechanism detecting a pressed state, according to some embodiments.

FIG. 4 illustrates an example simplified flow diagram for sensing key press activation in a music device, according to some embodiments.

FIG. 5 is a side-view diagram showing an example sensing mechanism detecting a half-way state, according to some embodiments.

FIG. 6 is a side-view diagram showing an example sensing mechanism detecting a neutral state, according to some embodiments.

### DETAILED DESCRIPTION OF EMBODIMENTS

Embodiments generally relate to sensing key press activation in a musical device. In various embodiments, the musical device includes a keyboard having keys. In one embodiment, an emitter below each key provides a signal that reflects off of the bottom of the key. A processor determines the movement of the key based on the reflection of the signal. In some embodiments, for each key, the signal passes through a channel that guides the signal to a mirror coupled beneath the key. A sensor below the key detects the reflected signal based on a position of the key. For example, in some embodiments, the sensor detects the signal when the key is in a pressed state.

As a result, the user has the experience of producing music with more precision and authenticity to particular musical instruments.

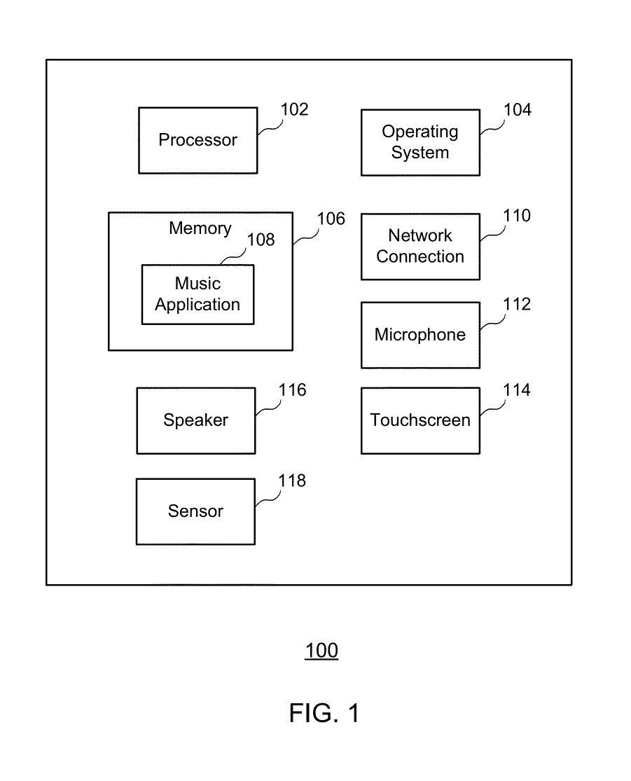

FIG. 1 is a block diagram of an example system 100, which may be used to implement the embodiments described herein. In some embodiments, computer system 100 may include a processor 102, an operating system 104, a memory 106, a music application 108, a network connection 110, a microphone 112, a touchscreen 114, a speaker 116, and a sensor 118.

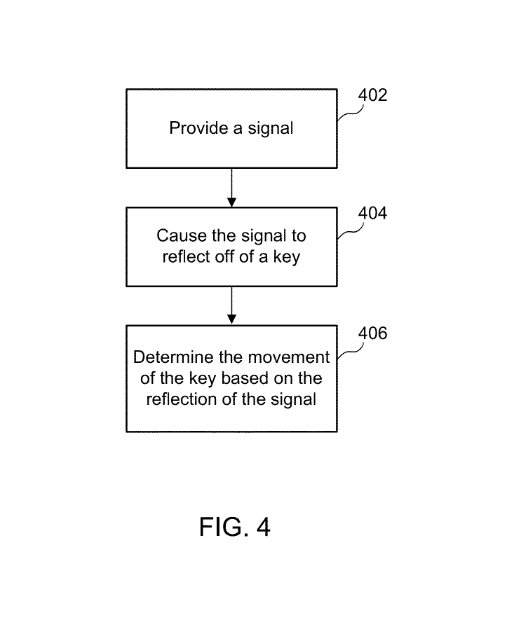

For ease of illustration, the blocks shown in FIG. 4 are shown as individual units. In various embodiments, these blocks may each represent multiple units. In other embodiments, system 100 may not have all of the components shown and/or may have other elements including other types of elements instead of, or in addition to, those shown herein.

Music application 108 may be stored on memory 106 or on any other suitable storage location or computer-readable medium. In various embodiments, music application 108 provides instructions that enable processor 102 to perform the functions described herein. In various embodiments, music application 108 may run on any electronic device including smart phones, tablets, computers, etc.

In various embodiments, touchscreen 114 may include any suitable interactive display surface or electronic visual display that can detect the presence and location of a touch within the display area. Touchscreen 114 may support touching the display with a finger or hand, or any suitable passive object, such as a stylus. Any suitable display technology (e.g., liquid crystal display (LCD), light emitting diode (LED), etc.) can be employed in touchscreen 114. In addition, touchscreen 114 in particular embodiments may utilize any type of touch detecting technology (e.g., resistive, surface acoustic wave (SAW) technology that uses ultrasonic waves that pass over the touchscreen panel, a capacitive touchscreen with an insulator, such as glass, coated with a transparent conductor, such as indium tin oxide (ITO), surface capacitance, mutual capacitance, self-capacitance, projected capacitive touch (PCT) technology, infrared touchscreen technology, optical imaging, dispersive signal technology, acoustic pulse recognition, etc.).

In various embodiments, processor 102 may be any suitable processor or controller (e.g., a central processing unit (CPU), a general-purpose microprocessor, a microcontroller, a microprocessor, etc.). Further, operating system 104 may be any suitable operating system (OS), or mobile OS/platform, and may be utilized to manage operation of processor 102, as well as execution of various application software. Examples of operating systems include Android from Google, iPhone OS (iOS), Berkeley software distribution (BSD), Linux, Mac OS X, Microsoft Windows, and UNIX.

In various embodiments, memory 106 may be used for instruction and/or data memory, as well as to store music and/or video files created on or downloaded to system 100. Memory 106 may be implemented in one or more of any number of suitable types of memory (e.g., static random access memory (SRAM), dynamic RAM (DRAM), electrically erasable programmable read-only memory (EEPROM), etc.). Memory 106 may also include or be combined with removable memory, such as memory sticks (e.g., using flash memory), storage discs (e.g., compact discs, digital video discs (DVDs), Blu-ray discs, etc.), and the like. Interfaces to memory 106 for such removable memory may include a universal serial bus (USB), and may be implemented through a separate connection and/or via network connection 110.

In various embodiments, network connection 110 may be used to connect other devices and/or instruments to system 100. For example, network connection 110 can be used for wireless connectivity (e.g., Wi-Fi, Bluetooth, etc.) to the Internet (e.g., navigable via touchscreen 114), or to another device. Network connection 110 may represent various types of connection ports to accommodate corresponding devices or types of connections. For example, additional speakers (e.g., Jawbone wireless speakers, or directly connected speakers) can be added via network connection 110. Also, headphones via the headphone jack can also be added directly, or via wireless interface. Network connection 110 can also include a USB interface to connect with any USB-based device.

In various embodiments, network connection 110 may also allow for connection to the Internet to enable processor 102 to send and receive music over the Internet. As described in more detail below, in some embodiments, processor 102 may generate various instrument sounds coupled together to provide music over a common stream via network connection 110.

In various embodiments, speaker 116 may be used to play sounds and melodies generated by processor 102. Speaker 116 may also be supplemented with additional external speakers connected via network connection 110, or multiplexed with such external speakers or headphones.

In some embodiments, sensor 118 may be a non-contact sensor. In some embodiments, sensor 118 may be an optical non-contact sensor. In some embodiments, sensor 118 may be a near-infrared optical non-contact sensor. As described in more detail below, in various embodiments, sensor 118 enables other embodiments described herein.

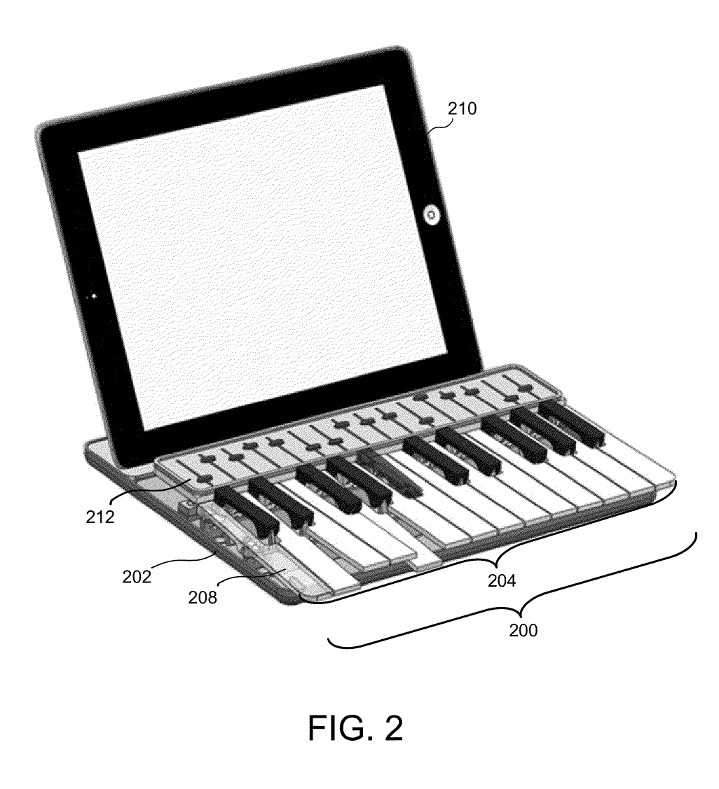

FIG. 2 is a perspective-view diagram showing an example music device 200, according to some embodiments. In various embodiments, music device 200 may be used to implement system 100 of FIG. 1. As shown, music device 200 includes a base 202 and a keyboard 204 having keys (e.g., key 208).

In various embodiments, music device 200 is configured to couple to a tablet computer 210. Music device 200 is operable to communicate with tablet computer 210, which can provide controls, sheet music, etc., to facilitate a user in creating music. In some embodiments, music device 200 may include one or more input/output (I/O) modules 212 that have controls (e.g., physical sliders, knobs, buttons, etc.), which may communicate with keyboard 204 and/or with a computer such as tablet computer 210 via a wired connection or wirelessly. Such connections may be achieved using any suitable connection means (e.g., hard wire, Bluetooth, Wi-Fi, IR, etc.).

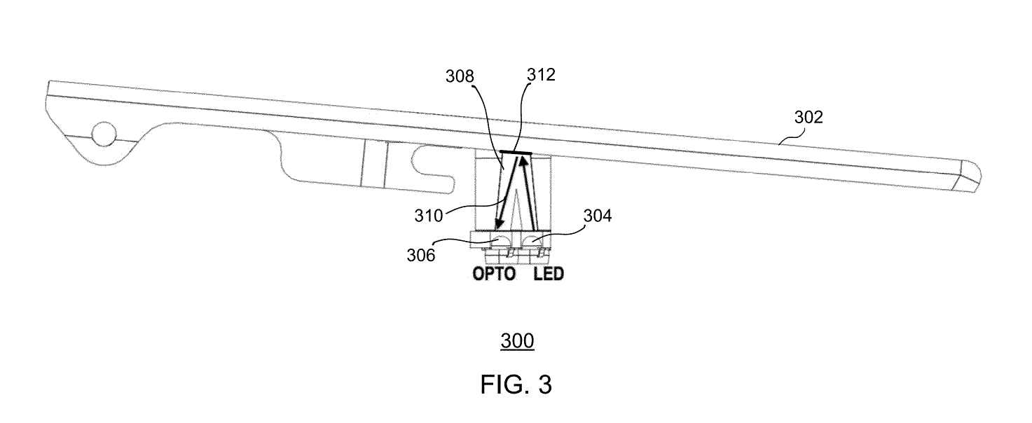

FIG. 3 is a side-view diagram showing an example sensing mechanism 300 detecting a pressed state, according to some embodiments. As shown, a key 302 of sensing mechanism 300 is in a pressed state. For example, a user may be have completely pressed down on key 302 as the user plays musical instrument 200, where key 302 may represent one of many keys of a piano keyboard (e.g., keyboard 204 of FIG. 2.) For ease of illustration, some embodiments are described herein in the context of key 302, which is a white key. These embodiments and others also apply to black keys or to any keys or devices that can be depressed on electronic musical instruments (e.g., foot pedals that control volume, etc.).

As shown, sensing mechanism 300 also includes an emitter 304 (also labeled “LED”), a sensor 306 (also labeled “OPTO”), and a channel 308. In various embodiments, sensor 306 may be used to implement sensor 118 of FIG. 1.

As described in more detail below, in various embodiments, sensing mechanism 300 senses various positions of key 302 based on a signal 310 that emitter 304 reflects off of key 302, where sensor 306 detects signal 310 depending on the position of key 302. In various embodiments, sensor 306 may be any suitable non-contact sensor such as a photo diode, photo transistor, etc.

In some embodiments, emitter 304 and sensor 306 are coupled to suitable a portion of the music device (e.g., music device 200) that is beneath key 302. For example, in some embodiments, emitter 304 and sensor 306 may be coupled or mounted to a circuit board beneath key 302. In some embodiments, emitter 304 and sensor 306 may be coupled or mounted to a base of the music device (e.g., music device 200).

In various embodiments, key 302 moves or traverses (rotates along) a range of motion when a user presses key 302. In various embodiments, when key 302 reaches a trigger point at a predetermined threshold angle, processor 102 causes a sound to be generated in response to key 302 reaching the trigger point. In various embodiments, different predetermined threshold angles may correspond to different trigger points. In various embodiments, system 100 detects different positions of key 302, where the different positions correspond to the different predetermined threshold angles.

In some embodiments, processor 102 assigns a different trigger point to different analog representations of the positions of each of the keys. For example, when key 302 travels downward and reaches a particular position, processor 102 may cause a corresponding piano sound (or other user-selected sound) to begin even before key 302 reaches the bottom of its range of motion. In some embodiments, the predetermined threshold angles may differ, depending on the particular instrument or sound selected by the user. For example, different instruments (e.g., piano, harpsichord, organ, etc.) may have different sound characteristics associated with different predetermined threshold angles.

In some embodiments, varying resistance at a given key may be achieved using electromagnetic technologies. For example, in some embodiments, magnets and spacers may be used to provide resistance when keys are pressed. In some embodiments, the position of magnets and spacers may be changed (e.g., lowered/raised) in order to modify the resistance of keys. In some embodiments, the magnets may be held in place by clips, with the spacers between magnets. In some embodiments, springs may be used to provide resistance, and different spring tensions may be used to modify the resistance of the springs.

In some embodiments, emitter 304 is a light emitting diode (LED) that emits signal 310, which may be a light signal, an infrared light signal, etc. In some embodiments, sensor 306 is a optical sensor that detects signal 310. In various embodiments, sensor 306 is a non-contact sensor (e.g., an optical non-contact sensor). In various embodiments, because a non-contact sensor is used, the signal detected from a key press of a corresponding key is a continuous analogue variable (rather than a discreet variable). In other words, the information determined from the movement of a given key is continuous. Although, in some embodiments, system 100 may interpret detection of signals by sensor 306 to be discreet or to be binary (e.g., key 302 is either in a pressed state or in a neutral state). This may be the case for some musical instruments such as a harpsichord.

For ease of illustration, sensing mechanism 300 includes a single emitter 304 and a single sensor 306 corresponding to key 302. In various embodiments, sensing mechanism 300 may include multiple emitters and multiple sensors, depending on the particular implementation.

In various implementations, emitter 304 emits signal 310 upward in the form of a light beam toward key 302, where the light beam is shaped like a cone (e.g., a 30 degree cone, etc.) or 3-dimensional inverted triangle. In some instances, the cone may have more area than the surface area that key 302 provides. In other words, the light beam may be wider than key 302.

In various embodiments, channel 308 functions to guide signal 310 to key 302, where signal 310 reflects off of key 302. Channel 308 may be referred to as an optical sensing channel. Channel 308 provides a light tunnel/light pipe for each signal component. As a result, in various embodiments, channel 308 causes the light beam to be substantially the same width or a smaller width than key 302. In various embodiments, channel 308 facilitates system 100 in providing precise key press activation.

In some embodiments, signal 310 reflects off of a mirror 312 that is positioned beneath key 302. In some embodiments, mirror 312 is coupled directly beneath key 302. In various embodiments, mirror 312 may be sized such that it covers the image spot of signal 310 (e.g., the width of the light beam), the size of which will depend on channel 308. In some embodiments, signal 310 may reflect off of key 302 at a predetermined range (e.g., 11 to 15 degrees) off the vertical axis. The intersection of two cones (e.g., emitter cone and sensor response area) may be referred to as the “active zone,” which may produce a 2-dimensional football-shaped overlapping cone on the underside of key 302, where the two cones overlap (e.g., up and down, emitter and sensor, etc.).

Note that while some embodiments are described in the context of mirror 312 reflecting signal 310, in some embodiments, key 302 may reflect signal 302 without mirror 312. For example, in some embodiments, key 302 may have a reflective surface that functions similarly to mirror 312 in order to reflect signal 310. As such, where descriptions herein refer to key 302 reflecting signal 310, or signal 310 reflecting off of key 302, such descriptions and associated embodiments apply equally to signal 302 reflecting directly off of key 302 and/or signal 302 reflecting off of mirror 312 which is coupled to key 302. This is because, in various embodiments, mirror 312 when coupled to key 302 is parallel to the bottom surface of key 302. As such, with or without mirror 312, the angle of reflection is the same.

In some scenarios, signal 310 may be subject to ambient light. In various embodiments, channel 308 minimizes and/or eliminates the possibility of ambient light reaching sensor 306. In some embodiments, channel 308 is opaque such that ambient light will not be reflected toward sensor 306.

As described in more detail below, in various embodiments, channel 308 also functions to guide signal 310 toward the direction of sensor 306, after being reflected off of key 302 (or mirror 312). As shown in FIG. 3, channel 308 may be described as a channel having shape of an inverted “V,” where one leg guides signal 310 from emitter 304 to key 302 (or to mirror 312), and where another leg guides signal 310 from key 302 (or mirror 312) to sensor 306. In some embodiments, channel 308 may be described as two separate channels where one channel guides signal 310 from emitter 304 to key 302 (or to mirror 312), and where another channel guides signal 310 from key 302 (or mirror 312) to sensor 306.

In some embodiments, the portion of channel 308 closest to key 302 does not make contact with key 302. In various embodiments, a gap exists between channel 308 and key 302 such that the gap is large enough to still allow key 302 to travel up and down without hitting channel 308.

As indicated above, sensor 306 detects signal 310 based on the position of key 302. The position of key 302 controls the angle at which signal 310 reflects off of key 302 and hits sensor 306 via channel 308. Examples are described in detail below in connection with FIGS. 4 through 6.

For ease illustration, some embodiments are described in the context of emitter 304 and sensor 306 being in line with (e.g., parallel to) key 302. These embodiments and others may also apply in the context of emitter 304 and sensor 306 being orthogonal to (e.g., perpendicular to) key 302.

FIG. 4 illustrates an example simplified flow diagram for sensing key press activation in a music device, according to some embodiments. Referring to both FIGS. 1, 3, and 4, a method is initiated in block 402 where system 100 provides a signal 310 in an electronic device such as a music device. In various implementations, system 100 causes emitter 304 to emit signal 310 toward key 302. While some embodiments are described in the context of a single key 302, these embodiments and others also apply to each of the other keys of the music device.

In block 404, system 100 causes signal 310 to reflect off of key 302. In various embodiments, emitter 304 is positioned such that any signal emitted from emitter 304 is aimed in the direction of key 302. As indicated above, in various embodiments, channel 308 of sensor mechanism 300 guides signal 310 in the direction of key 302. As a result, signal 310 reflects off of key 302.

In various embodiments, as key 302 is pressed down, the alignment of mirror 312 improves such that signal 310 eventually sweeps over channel 308 (e.g., front-to-back). In various embodiments, at the bottom of the key press, sensor 306 detects signal 310 at a the maximum intensity, where the amplitude of signal 310 is at a maximum.

In block 406, system 100 determines the movement of key 302 based on the reflection of signal 310 off of key 302. In various embodiments, signal 310 being reflected off of key 302 is a continuous analogue variable, which changes as key 302 changes positions (e.g., travels down or travels up).

In some embodiments, the amount of signal strength detected by sensor 306 varies as corresponding key 302 moves up and down, because the angle at which signal 302 is reflected off of key 302 will change as key 302 moves up and down. As a result, the detected amount of signal strength corresponds to a particular key position. As such, system 100 may ascertain the position of a given key based on the amount of signal strength detected by sensor 306. Furthermore, system 100 may assign a trigger point at which the position of the key triggers a sound.

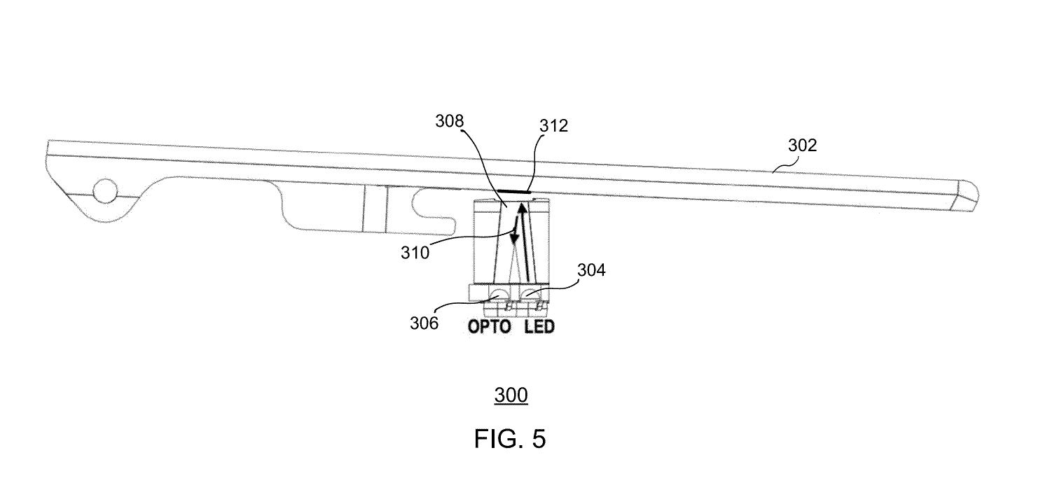

FIG. 5 is a side-view diagram showing sensing mechanism 300 detecting a half-way state, according to some embodiments. As shown, key 302 is in a half-way state. For example, the user may be pressing down on key 302 as the user plays the musical instrument, such that key 302 is traveling downward from a fully-raised neutral state to a completely-lowered pressed state. The position shown in FIG. 5 may also illustrate the user letting up on key 302, such that key 302 is traveling upward from a completely-lowered or partially lowered pressed state to a fully-raised neutral state.

For ease of illustration, a half-way state is described in the example shown. More broadly, the half-way state may also be described as a transition state. System 100 may determine other key positions of different transition states. In other words, system 100 may detect key 302 in other positions (e.g., anywhere between the completely-lowered pressed state and the half-way state, anywhere between the half-way state and the fully-raised neutral state).

In such a half-way state as shown, sensor 306 still detects signal 310 but the relative signal strength (e.g., the amplitude) is decreased. In various embodiments, the changes in signal strength are linear such that system 100 determines the position of key 302 with precision. Furthermore, system 100 may also detect the velocity of key 302 based on the positional change of key 302 over a time period.

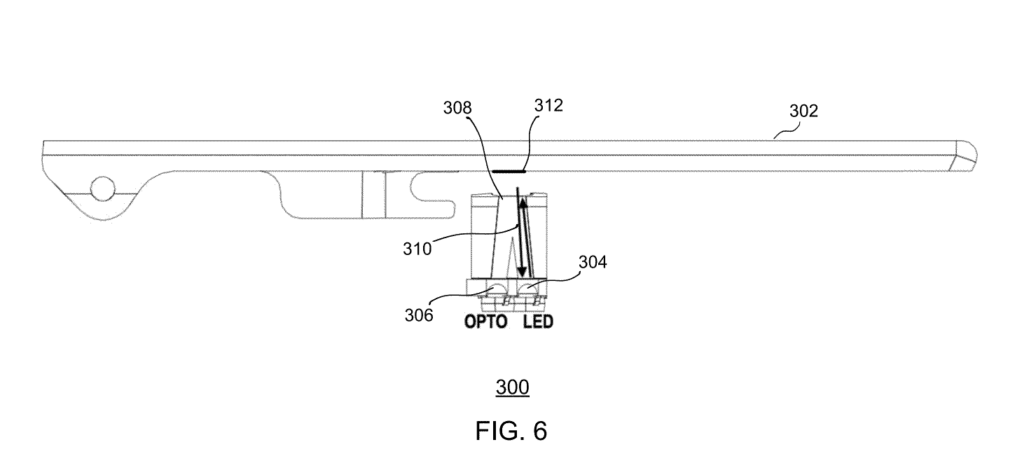

FIG. 6 is a side-view diagram showing sensing mechanism 300 detecting a neutral state, according to some embodiments. As shown, key 302 is in a half-way state. For example, the user may be pressing down on key 302 as the user plays the musical instrument, such that key 302 is traveling downward from a fully-raised neutral state to a completely-lowered pressed state.

In various embodiments, the fully-raised state may be referred to as a neutral state, because the neutral state is a state where the user is not applying any force to key 302. In other words, the fully-raised state is the default state of key 302 when no external pressure is applied to key 302.

In various embodiments, the when key 302 moves back-and-forth between the pressed state and the neutral state, the angle of reflection at which signal 310 reflects off of key 302 changes a small amount (e.g., 5.5 degrees). The amount is enough for sensor 306 to either detect signal 302 or not.

The range of the angle of reflection may vary depending on the distance between emitter 304 and sensor 306. In some embodiments, emitter 304 and sensor 306 lie side-by-side in close proximity to each other (e.g., 4 mm apart, etc.).

As shown in FIG. 6, when key 302 is in the neutral state, the angle of reflection decrease toward 0 degrees such that signal 310 reflects substantially back toward emitter 304. As a result, sensor 306 does not detect signal 310.

As shown above in FIG. 3, when key 302 is in the pressed state, the alignment of key 302 (or mirror 312) improves. As such, the angle of reflection increase toward 5.5 degrees, for example, such that signal 310 reflects substantially toward sensor 306. As a result, sensor 306 detects signal 310 at a maximum intensity.

As shown above in FIG. 5, when key 302 is in a transition state (e.g., a half-way state), the angle of reflection is such that sensor 306 may still detect signal 310 but the signal strength is less (e.g., not at its maximum), where system 102 may determine the position of key 302 based on the relative signal strength.

Embodiments described herein enable a user to enjoy a music playing experience that is relatively close to that of playing a standard size musical instrument. Embodiments increase precision of action of a sensing mechanism in music devices having a keyboard.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method comprising:
providing a signal in an electronic device;
causing the signal to reflect off of a key of the electronic device; and
determining a movement of the key based on a reflection of the signal.

2. The method of claim 1, further comprising causing the signal to pass through a channel.

3. The method of claim 1, further comprising enabling a sensor to detect the signal based on a position of the key.

4. The method of claim 1, wherein the determining of the movement of the key comprises detecting the signal at a sensor, and wherein the signal is detected at the sensor when the key is in at least a first state.

5. The method of claim 1, wherein the determining of the movement of the key comprises detecting the signal at a sensor, wherein the signal is detected at the sensor when the key is in at least a first state, and wherein the first state is a pressed state.

6. The method of claim 1, wherein the electronic device is a music device.

7. The method of claim 1, wherein the electronic device comprises a keyboard having a plurality of keys, and wherein the method comprises determining the movement of two or more of the keys based on reflections of signals.

8. A system comprising:
one or more processors; and
logic encoded in one or more tangible media for execution by the one or more processors, and when executed operable to perform operations comprising:
providing a signal in an electronic device;
causing the signal to reflect off of a key of the electronic device; and
determining a movement of the key based on a reflection of the signal.

9. The system of claim 8, wherein the logic when executed is further operable to perform operations comprising causing the signal to pass through a channel.

10. The system of claim 8, wherein the logic when executed is further operable to perform operations comprising enabling a sensor to detect the signal based on a position of the key.

11. The system of claim 8, wherein, to determine the movement of the key, the logic when executed is further operable to perform operations comprising detecting the signal at a sensor, and wherein the signal is detected at the sensor when the key is in at least a first state.

12. The system of claim 8, wherein, to determine the movement of the key, the logic when executed is further operable to perform operations comprising detecting the signal at a sensor, wherein the signal is detected at the sensor when the key is in at least a first state, and wherein the first state is a pressed state.

13. The system of claim 8, wherein the electronic device is a music device.

14. The system of claim 8, wherein the electronic device comprises a keyboard having a plurality of keys, and wherein the logic when executed is further operable to perform operations comprising determining the movement of two or more of the keys based on reflections of signals.

15. An electronic device comprising:
an emitter that provides a signal in the electronic device, wherein the signal reflects off of a key of the electronic device; and
a processor that determines a movement of the key based on a reflection of the signal.

16. The electronic device of claim 15, further comprising a channel through which the signal passes.

17. The electronic device of claim 15, further comprising a sensor that detects the signal based on a position of the key.

18. The electronic device of claim 15, further comprising a sensor that detects the signal when the key is in at least a first state.

19. The electronic device of claim 15, further comprising a sensor that detects the signal when the key is in at least a first state, wherein the first state is a pressed state.

20. The electronic device of claim 15, wherein the electronic device is a music device.
